(19) United States
(12) Patent Application Publication
(10) Pub. No.: US 2012/0017245 A1
(43) Pub. Date: Jan. 19, 2012

(54) METHOD AND SYSTEM FOR PROVIDING PROGRAMMING GUIDE AND RECORDING INFORMATION VIA AN IP MULTIMEDIA GATEWAY

(76) Inventors: Xuemin Chen, Rancho Santa Fe, CA (US); Gordon Yong Li, San Diego, CA (US)

(21) Appl. No.: 12/837,045

(22) Filed: Jul. 15, 2010

(51) Int. Cl. H04N 5/445

(52) U.S. Cl. 725/54

(57) ABSTRACT

An IP multimedia gateway (IMG) may be operable to determine capability and/or capacity of a client device to render graphics for a received programming guide. The IMG may be operable to convert the programming guide from a first format to a second format based on the determined capability and/or capacity of the client device. The converted programming guide may be communicated by the IMG to the client device. The IMG may be operable to determine a recording capability and/or capacity of the client device. A storage location may be determined by the IMG for storing the recording of the one or more of the video programs based on the determined recording capability and/or capacity of the client device. The client device may record the one or more of the video programs utilizing the converted programming guide and the determined storage location.

### CROSS-REFERENCE TO RELATED APPLICATIONS/INCORPORATION BY REFERENCE

This application makes reference to:

U.S. patent application Ser. No. ______ (Attorney Docket No. 23032US01) filed on ______;
U.S. patent application Ser. No. ______ (Attorney Docket No. 23033US01) filed on ______;
U.S. patent application Ser. No. ______ (Attorney Docket No. 23034US01) filed on ______;
U.S. patent application Ser. No. ______ (Attorney Docket No. 23035US01) filed on ______;
U.S. patent application Ser. No. ______ (Attorney Docket No. 23036US01) filed on ______;
U.S. patent application Ser. No. ______ (Attorney Docket No. 23038US01) filed on ______; and
U.S. patent application Ser. No. ______ (Attorney Docket No. 23039US01) filed on ______.

Each of the above stated applications is hereby incorporated herein by reference in its entirety.

### FIELD OF THE INVENTION

Certain embodiments of the invention relate to communication systems. More specifically, certain embodiments of the invention relate to a method and system for providing programming guide and recording information via an IP multimedia gateway.

### BACKGROUND OF THE INVENTION

Telecommunication technologies have evolved from analog to digital technologies, and continues to evolve from circuit switched to packet switched, from connection oriented packet switching to connectionless packet switching, and from narrow band application to broadband applications. The accompanied evolution in telecommunication technologies has significantly advanced operators' capability to offer broadband, IP-based multimedia services ranging from entertainment and lifestyle applications such as mobile TV and mobile payment to professional services such as video conferencing and real-time data exchange.

IP multimedia subsystem (IMS) defines an architectural framework for the deployment of IP multimedia services. IMS defines how these services connect and communicate with the underlying telecommunications network(s) and how they integrate with the network provider's back-end systems. IMS combines voice and data in one packet switched network such as, for example, the GPRS core network and the LTE core network, to offer network controlled multimedia services. Various Internet Protocols (IPs) such as the Session Initiation Protocol (SIP), the User Datagram Protocol (UDP), the Transmission Control Protocol (TCP) and Real-Time Transport Protocol (RTP) are widely utilized for delivery of various forms of multimedia applications over IP networks. SIP is an end-to-end application layer signaling protocol that is utilized to setup, modify, and teardown multimedia sessions such as audio/videoconferencing, interactive gaming, virtual reality, and call forwarding over IP networks. UDP and TCP are transport layer protocols that are used for data delivery over IP networks. TCP guarantees data delivery and integrity, however, UDP does not exclusively guarantee delivery of data. RTP is the Internet protocol which transmits real-time data such as audio and video data. RTP does not exclusively guarantee real-time delivery of data, but it does provide mechanisms for the sending and receiving applications to support streaming data.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for providing programming guide and recording information via an IP multimedia gateway, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary communication system that is operable to provide programming guide and recording information via an IP multimedia gateway, in accordance with an embodiment of the invention.

FIG. 2 is a block diagram illustrating an exemplary video receiver that is operable to provide programming guide and recording information via an IP multimedia gateway, in accordance with an embodiment of the invention.

FIG. 3 is a block diagram illustrating an exemplary IP multimedia gateway (IMG) that is operable to provide programming guide and recording information via the IP multimedia gateway, in accordance with an embodiment of the invention.

FIG. 4 is a flow chart illustrating exemplary steps for providing programming guide via an IP multimedia gateway, in accordance with an embodiment of the invention.

FIG. 5 is a flow chart illustrating exemplary steps for providing recording information via an IP multimedia gateway, in accordance with an embodiment of the invention.

### DETAILED DESCRIPTION OF THE INVENTION

Certain embodiments of the invention can be found in a method and system for providing programming guide and recording information via an IP multimedia gateway. In various embodiments of the invention, an IP multimedia gateway (IMG) may be operable to determine capability and/or capacity of a client device, which may be communicatively coupled to the IMG, to render graphics for a received programming guide. The IMG may be operable to convert the received programming guide from a first format to a second format based on the determined capability and/or capacity of the client device. The converted programming guide may be communicated by the IMG to the client device. In this regard, for example, the converted programming guide may be pushed, by the IMG, from the IMG to the client device. The converted programming guide may be pulled, from the IMG, by the client device.

In an exemplary embodiment of the invention, the IMG may be integrated within a video receiver and the programming guide may be generated by the video receiver. In another exemplary embodiment of the invention, the programming guide may be received by the IMG from an entity whose location may be remote with respect to a location of the IMG.

In an exemplary embodiment of the invention, the IMG may be operable to determine a recording capability and/or capacity of the client device for recording one or more of video programs associated with the programming guide. A storage location may be determined by the IMG for storing the recording of the one or more of the video programs based on the determined recording capability and/or capacity of the client device. The client device may record the one or more of the video programs utilizing the converted programming guide and the determined storage location. In this regard, for example, the client device may record the one or more of the video programs to the client device in instances when the client device may comprise a storage capability and/or capacity to store the recording of the one or more of the video programs. The client device may record the one or more of the video programs into a digital video recorder (DVR) in a video receiver communicatively coupled to the IMG in instances when the client device may not comprise a storage capability and/or capacity to store the recording of the one or more of the video programs. The client device may record the one or more of the video programs into a storage device that may be local to the IMG in instances when the client device may not comprise a storage capability and/or capacity to store the recording of the one or more of the video programs, for example. The client device may record the one or more of the video programs into a storage device that may be remote with respect to the IMG in instances when the client device may not comprise a storage capability and/or capacity to store the recording of the one or more of the video programs, for example.

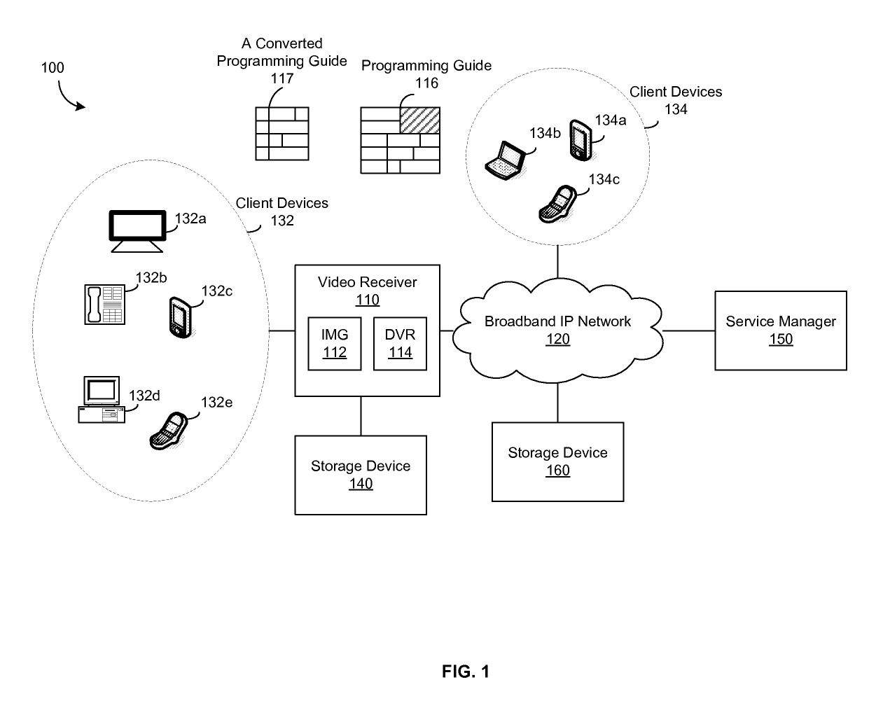

FIG. 1 is a block diagram illustrating an exemplary communication system that is operable to provide programming guide and recording information via an IP multimedia gateway, in accordance with an embodiment of the invention. Referring to FIG. 1, there is shown a communication system 100. The communication system 100 may comprise a video receiver 110, a broadband IP network 120, a plurality of client devices 132a-132e, 134a-134c, which are collectively referred to herein as client devices 132 and 134 respectively, a service manager 150, a storage device 140 and a storage device 160.

The video receiver 110 may comprise suitable logic, circuitry, interfaces and/or code that may be operable to receive video programs or content from the service manager 150 via the broadband IP network 120 and/or from a non-IP broadcast channel. The video receiver 110 may be, for example, a set-top box (STB) and/or a digital TV (TDV). The video receiver 110 may comprise an IMG 112 and a DVR 114. In an exemplary embodiment of the invention, the video receiver 110 may be operable to generate a programming guide such as the programming guide 116 for viewing, scheduling and/or recording video programs. The programming guide 116 such as, for example, an electronic program guide (EPG) may provide users of the video receiver 110 with continuously updated menus that may display scheduling information for the current and/or upcoming programming events. The programming guide 116 may allow users of the video receiver 110 to navigate scheduling information menus interactively, and/or to select and discover programming by, for example, time, title, genre, channel and/or other criteria. In this regard, the associated video programs may comprise content that may be provided by the service manager 150 and/or from a non-IP broadcast channel. The associated video programs may comprise content that may have been recorded in the DVR 114, for example.

The IMG 112, which is integrated in the video receiver 110, may comprise suitable logic, circuitry, interfaces and/or code that may be operable to connect the client devices 132 to the broadband IP network 120 for services of interest. A service may be described or represented by the service type and the service class. The type of a service refers to as the type of information to be transferred such as data, voice, text or video for the service. A service with a given service type may be classified into a plurality of exemplary scheduling service classes, namely, data services for Internet access and messaging, conversational services for carrier-grade voice and/or video calls and conferences, video services for TV, video and music streaming, gaming services for users to interact with one another via a central server, and corporate VPN services for access to enterprise intranet/email. Specific requirements may be placed on access networks of the client devices 132 and the broadband IP network 120 for each service type and/or class to ensure desired end-to-end quality of service (QoS). The service requirements on access networks of the client devices 132 and the broadband IP network 120 may comprise, for example, system timing, CODEC, transmission rates, power-saving mechanisms, security profiles and content types.

In various exemplary embodiments of the invention, the IMG 112 may be operable to integrate local client devices as well as remote client devices to the broadband IP network 120. Client devices such as the client devices 132a-132e that may access the IMG 112 via device-dependent interfaces are referred to as local client devices for the IMG 112. A device-dependent interface may generally represent the PHY and MAC functionality of a particular access technology such as, for example, Ethernet, Wi-Fi, Bluetooth, cordless, and/or Femtocell. Client devices such as the client devices 134a-134c that may access the IMG 112 remotely via device-independent interfaces such as the broadband IP network 120 are referred to as remote client devices for the IMG 112. The IMG 112 may also be operable to provide interfaces between a client device, such as the client device 132a or the client device 134a, and the video receiver 110 for services provided by the video receiver 110.

In an exemplary embodiment of the invention, the IMG 112 may be operable to identify a graphics processing capability and/or capacity of a client device such as the client device 132a for rendering a programming guide such as the programming guide 116. The programming guide 116 may be generated by the video receiver 110 for viewing, scheduling and/or recording video programs. The IMG 112 may be operable to convert the programming guide 116 from one format to another format so as to generate a converted programming guide 117 that may be compatible with the identified graphics processing capability and/or capacity of the client device 132a. The converted programming guide 117 may be delivered by the IMG 112 to the client device 132a. A location of the client device such as the client device 132a may be local with respect to a location of the IMG 112. A location of the client device such as the client device 134a may be remote with respect to a location of the IMG 112.

In an exemplary embodiment of the invention, the IMG 112 may be operable to identify a recording capability and/or capacity of the client device such as the client device 132a for recording one or more of the video programs by the client device 132a. A storage location may be determined by the IMG 112 for storing the recording of the one or more of the video programs based on the recording capability and/or capacity of the client device 132a. The client device 132a may record the one or more of the video programs utilizing the converted programming guide 117 and the determined storage location. In this regard, for example, the client device 132a may record the one or more of the video programs into the client device 132a in instances when the client device 132a may comprise a storage capability and/or capacity for storing the recording of the one or more of the video programs. The client device 132a may record the one or more of the video programs into a DVR 114 in the video receiver 110 in instances when the client device 132a may not comprise a storage capability and/or capacity for storing the recording of the one or more of the video programs. The client device 132a may record the one or more of the video programs into a storage device such as the storage device 140 that may be local to the IMG 112 in instances when the client device 132a may not comprise a storage capability and/or capacity for storing the recording of the one or more of the video programs, for example. The client device 132a may record the one or more of the video programs into a storage device such as the storage device 160 that may be remote with respect to the IMG 112 in instances when the client device 132a may not comprise a storage capability and/or capacity for storing the recording of the one or more of the video programs, for example.

The DVR 114 may comprise suitable logic, circuitry, interfaces and/or code that may be operable to record video in a digital format to a disk drive, USB flash derive, SD memory card or other memory medium within the DVR 114. In an exemplary embodiment of the invention, the DVR 114 may be operable to record one or more of video programs for a client device such as the client device 132a in instances when the client device 132a may not comprise a storage capability and/or capacity and/or capacity for storing the recording of the one or more of the video programs.

A client device such as the client device 132a may comprise suitable logic, circuitry, interfaces and/or code that may be operable to receive services from the service manager 150 via the broadband IP network 120 and the IMG 112. In various exemplary embodiments of the invention, the client device 132a may be operable to utilize an access technology specific interface such as Bluetooth, LTE, WiFi and/or Ethernet to communicate with the IMG 112 for services offered by the service manager 150 via the broadband IP network 120. The client device 132a may also be operable to communicate or exchange information with other client devices registered to the IMG 112. In this regard, the client device 132a may share information with local client devices such as client devices 132b-132e as well as remote client devices such as the client devices 134a-134c. The client device 132a may be dynamically configured to receive services via the broadband IP network 120 as well as networked client devices such as the client device 132e. In an exemplary embodiment of the invention, a client device such as the client device 132a may be operable to receive a version of a programming guide 117 from the IMG 112, based on a graphics processing capability and/or capacity and/or capacity of the client device 132a.

The service manager 150 may comprise suitable logic, circuitry, interfaces and/or code that may be operable to provide IP-based services to the client devices 132, 134 via the broadband IP network 120 and the IMG 112. In this regard, the server manager 150 may be configured to deliver carrier-grade as well as non-carrier-grade broadband access services to the client devices 132, 134. The server manager 150 may be operable to schedule delivery of carrier-grade services to ensure service integrity. Non-carrier-grade services may be delivered when needed without reliability and stability ensured, for example.

The broadband IP network 120 may comprise suitable logic, circuitry, communication devices, interfaces and/or code that may be operable to provide broadband communication via various wired and/or wireless technologies such as, for example, T1/E1, DSL, cable modem, FTTx, PLC and/or WiMAX. In an exemplary embodiment of the invention, the broadband IP network 120 may be operable to provide communication between the service manager 150 and the IMG 112, which is integrated in the video receiver 110.

A storage device, such as the storage device 140 or the storage device 160, may comprise suitable logic, circuitry, interfaces and/or code that may be operable to store recording of one or more of video programs for a client device such as the client device 132a, in instances when the client device 132a may not comprise a storage capability and/or capacity and/or capacity for storing the recording of the one or more of the video programs. A location of a storage device such as the storage device 140 may be local with respect to the location of the IMG 112. A location of a storage device such as the storage device 160 may be remote with respect to the location of the IMG 112.

In operation, the video receiver 110 may be operable to generate a programming guide such as the programming guide 116 for viewing, interacting with, manipulating, scheduling and/or recording of video programs. The programming guide 116 such as, for example, an EPG may provide users of the video receiver 110 with continuously updated menus that may display scheduling information for the current and/or upcoming programming events. The programming guide 116 may allow the users of the video receiver 110 to navigate scheduling information menus interactively, selecting and discovering programming by one or more criteria comprising, data, time, title, or channel. In this regard, the video programs may comprise content, that may be provided by the service manager 150 and/or from a non-IP broadcast channel. The video programs may comprise content that may have been recorded in the DVR 114, for example.

The IMG 112 may be operable to identify a graphics processing capability and/or capacity of a client device such as the client device 132a for rendering a programming guide such as the programming guide 116. The programming guide 116 may be generated by the video receiver 110 for viewing, scheduling and/or recording of associated video programs. The IMG 112 may be operable to convert the programming guide from one format to another format so as to generate a converted programming guide 117 that may be compatible with the identified graphics processing capability and/or capacity of the client device 132a. For example, a client device such as the client device 132e, which may be a mobile device with smaller screen and/or lower graphics resolution, may not have the same graphics processing capability and/or capacity of the client device 132a and/or the video receiver 110. Accordingly, different formats of the programming guide 116 may be generated for the client device 132a and the client device 132e respectively. The converted programming guide 117 may be communicated by the IMG 112 to the client device 132a. For example, the converted programming guide 117 may be pushed, by the IMG 112, from the IMG 112 to the client device 132a. The converted programming guide 117 may be pulled, from the IMG 112, by the client device 132a. In this regard, for example, a location of the client device such as the client device 132a may be local with respect to a location of the IMG 112. A location of the client device such as the client device 134a may be remote with respect to a location of the IMG 112.

In an exemplary embodiment of the invention, the IMG 112 may be operable to identify a recording capability and/or capacity and/or capacity of the client device such as the client device 132a for recording one or more of the video programs by the client device 132a. For example, a client device such as the client device 132e, which may be a mobile device, may not have a recording capability and/or capacity to record a video program due to limited storage capacity of the client device 132e. For example, a client device 132d may have a disk drive with a capacity to store 20 GB of data and another client device 132a may have a capacity to store 100 GB of data, and the video program to be recorded may need 25 GB storage capacity. A storage location may be determined by the IMG 112 for storing the one or more recorded video programs based on the recording capability and/or capacity of the client device 132a. The client device 132a may record the one or more of the video programs utilizing the delivered converted programming guide 117 and the determined storage location. In this regard, for example, the client device 132a may schedule a recording of one or more of the video programs utilizing the delivered converted programming guide 117. The client device 132a may be allowed to record the one or more of the video programs into the client device 132a in instances when the client device 132a may comprise a storage capability and/or capacity for storing the recording of the one or more of the video programs.

The client device 132a may be allowed to record the one or more of the video programs into a DVR 114 in the video receiver 110 in instances when the client device 132a may not comprise a storage capability and/or capacity for storing the recording of the one or more of the video programs. The client device 132a may be allowed to record the one or more of the video programs into a storage device such as the storage device 140 that may be local to the IMG 112 in instances when the client device 132a may not comprise a storage capability and/or capacity and/or capacity for storing the recording of the one or more of the video programs, for example. The client device 132a may be allowed to record the one or more of the video programs into a storage device such as the storage device 160 that may be located remotely with respect to the location of IMG 112 in instances when the client device 132a may not comprise a storage capability and/or capacity for storing the recording of the one or more of the video programs, for example.

In the exemplary embodiment of the invention illustrated in FIG. 1, the IMG 112 is integrated within the video receiver 110. Notwithstanding, the invention is not so limited. The IMG 112 that is located outside the video receiver 110 may be illustrated without departing from the spirit and scope of various embodiments of the invention.

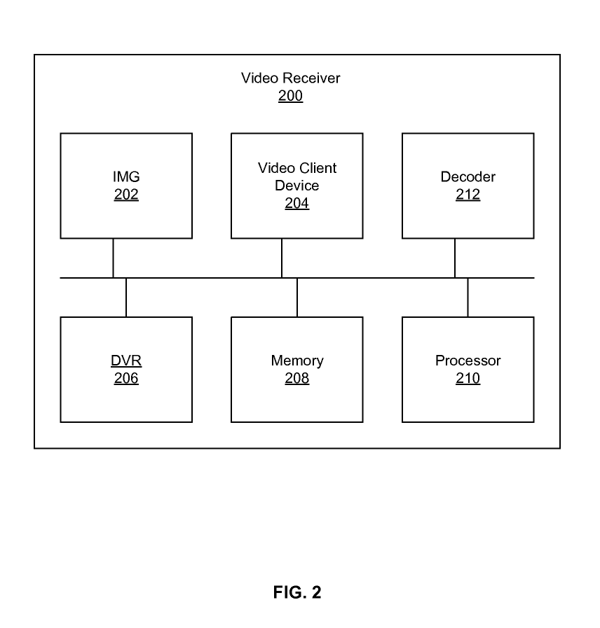

FIG. 2 is a block diagram illustrating an exemplary video receiver that is operable to provide programming guide and recording information via an IP multimedia gateway, in accordance with an embodiment of the invention. Referring to FIG. 2, there is shown a video receiver 200. The video receiver 200 may comprise an IMG 202, a video client device 204, a DVR 206, a memory 208 and a processor 210. The IMG 202 may be substantially the same as the IMG 112 described with respect to FIG. 1. The DVR 206 may be substantially the same as the DVR 114 described with respect to FIG. 1.

The video client device 204 may comprise suitable logic, circuitry, interfaces and/or code that may be operable to provide interface between the IMG 202 and a video processing subsystem of the video receiver 200, such as the processor 210 and/or the decoder 212, for various video processing functions. In an exemplary embodiment of the invention, the video client device 204 may be operable to generate a programming guide such as the programming guide 116. The programming guide 116 and/or a version of the programming guide 117 may be distributed by the IMG 202 to a plurality of client devices such as the client devices 132a-132e, 134a-134c.

The memory 208 may comprise suitable logic, circuitry, interfaces and/or code that may be operable to store information such as executable instructions and data that may be utilized by the processor 210 and/or the decoder 212, to perform various functions of the video receiver 200. The memory 208 may comprise RAM, ROM, low latency nonvolatile memory such as flash memory and/or other suitable electronic data storage capable of storing data and instructions.

The processor 210 may comprise suitable logic, circuitry, interfaces and/or code that may be operable to communicate with the decoder 212, the IMG 202 and/or the video client device 204 to perform various functions of the video receiver 200.

The decoder 212 may comprise suitable logic, circuitry, interfaces and/or code that may be operable to process or decode the audio and video streams of program content. The program content may be received from the service manager 150 via the broadband IP network 120 and/or from a non-IP broadcast channel, for example.

In operation, the video client device 204 may be operable to generate a programming guide such as the programming guide 116 for viewing, scheduling, interacting with, and/or recording of video programs. In this regard, the video programs may comprise content that may be provided by the service manager 150 and/or from a non-IP broadcast channel. The video programs may comprise content that may have been recorded in the DVR 206, for example.

The IMG 202 may be operable to identify a graphics processing capability and/or capacity of a client device such as the client device 132a for rendering a programming guide such as the programming guide 116. The programming guide 116 may be generated by the video client device 204 for viewing, scheduling and/or recording of video programs. The IMG 202 may be operable to convert the programming guide 116 from one format to another format so as to generate a converted programming guide 117 based on the identified graphics processing capability and/or capacity of the client device 132a. For example, a client device such as the client device 132e, which may be a mobile device with smaller screen and/or lower graphics resolution, may not have the same graphics processing capability and/or capacity of the client device 132a and/or the video receiver 110. Accordingly, different formats of the programming guide 116 may be generated for the client device 132a and the client device 132e respectively. The converted programming guide 117 may be communicated by the IMG 202 to the client device 132a. In this regard, for example, the converted programming guide 117 may be pushed, by the IMG 202, from the IMG 202 to the client device 132a. The converted programming guide 117 may be pulled, from the IMG 202, by the client device 132a. A location of the client device such as the client device 132a may be local with respect to a location of the IMG 202. A location of the client device such as the client device 134a may be remote with respect to a location of the IMG 202.

In an exemplary embodiment of the invention, the IMG 202 may be operable to identify a recording capability and/or capacity of the client device such as the client device 132a for recording one or more of the video programs by the client device 132a. For example, a client device such as the client device 132e, which may be a mobile device, may not have a recording capability and/or capacity to record a video program due to a limited amount of a storage capability and/or capacity of the client device 132e. A storage location may be determined by the IMG 202 for storing the recording of the one or more of the video programs based on the recording capability and/or capacity of the client device 132a. The client device 132a may record the one or more of the video programs utilizing the delivered converted programming guide 117 and the determined storage location. In this regard, for example, the client device 132a may schedule a recording of one or more of the video programs utilizing the delivered converted programming guide 117.

The client device 132a may be allowed to record the one or more of the video programs into the client device 132a in instances when the client device 132a may comprise a storage capability and/or capacity for storing the recording of the one or more of the video programs. The client device 132a may be allowed record the one or more of the video programs into a DVR 206 in instances when the client device 132a may not comprise a storage capability and/or capacity for storing the recording of the one or more of the video programs. The client device 132a may be allowed to record the one or more of the video programs into a storage device such as the storage device 140 that may be local to the IMG 202 in instances when the client device 132a may not comprise a storage capability and/or capacity for storing the recording of the one or more of the video programs, for example. The client device 132a may be allowed to record the one or more of the video programs into a storage device such as the storage device 160 that may be located remotely with respect to the location of IMG 202 in instances when the client device 132a may not comprise a storage capability and/or capacity for storing the recording of the one or more of the video programs, for example.

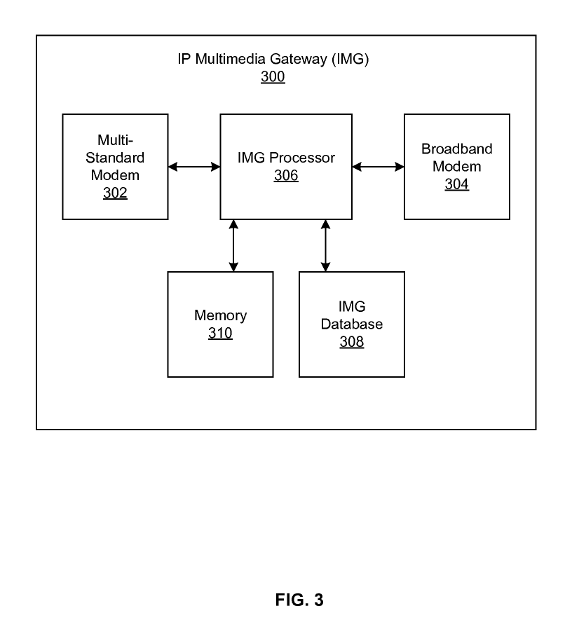

FIG. 3 is a block diagram illustrating an exemplary IP multimedia gateway (IMG) that is operable to provide programming guide and recording information via the IP multimedia gateway, in accordance with an embodiment of the invention. Referring to FIG. 3, there is shown an IMG 300. The IMG 300 may comprise a multi-standard modem 302, a broadband modem 304, an IMG processor 306, an IMG database 308 and a memory 310.

The multi-standard modem 302 may comprise suitable logic, circuitry, interfaces and/or code that may be operable to communicate with a plurality of client devices such as the client devices 132a-132e utilizing a device-dependent interface such as, for example, Ethernet, Wi-Fi, Bluetooth, cordless, and/or Femtocell. In an exemplary embodiment of the invention, the multi-standard modem 302 may be operable to communicate with the video client device 204 in the video receiver 200. The multi-standard modem 302 may also be operable to communicate with a local storage device such as the storage device 140.

The broadband modem 304 may comprise suitable logic, circuitry, interfaces and/or code that may be operable to transmit voice and/or data in adherence with one or more internet protocol (IP) broadband standard. The broadband modem 304 may be operable to transmit and/or receive voice and/or data to and/or from the broadband IP networks 120 over broadband connections such as, for example, T1/E1 line, DSL, Cable, FTTx, PLC and WiMAX. The broadband modem 304 may dynamically configure one or more network interfaces utilized within the broadband modem 304 towards to the broadband IP network 120. For example, in instances where the broadband modem 304 is signaled to exchange information with the service manager 150, the broadband modem 304 may be configured to utilize FTTx as an access solution to the service manager 150.

The IMG processor 306 may comprise suitable logic, circuitry, interfaces and/or code that may be operable to perform a variety of signal processing tasks to maintain or manage communication between associated client devices 132a-132e, 134a-134c and the broadband IP network 120, and/or among associated client devices 132a-132e, 134a-134c. The IMG processor 306 may be operable to perform a plurality of functions such as, for example, client device interface, client device adaptation, internal routing and control, remote access, broadband IP network adaptation and/or broadband IP network interface.

The IMG database 308 may comprise suitable logic, circuitry, interfaces and/or code that may be operable to store and manage client device information and network information. In this regard, the IMG database 308 may comprise registration status information for associated client devices such as client devices 132a-132e, 134a-134c. The registration status for a client device pertaining to the IMG 300 may be a local client device such as the client device 132a or a remote client device such as the client device 134a. The IMG database 308 may be operable to track or collect client device capabilities and network capabilities. The collected capability information may be utilized to dynamically configure client devices 132a-132e, 134a-134c pertaining to the IMG 300.

The memory 310 may comprise suitable logic, circuitry, interfaces and/or code that may be operable to store information such as executable instructions and data that may be utilized by the IMG processor 306 to perform various functions of the IMG 300. For example, the memory 310 may be utilized to store processed data or content generated by the IMG processor 306. The memory 310 may comprise RAM, ROM, low latency nonvolatile memory such as flash memory and/or other suitable electronic data storage capable of storing data and instructions.

In operation, an IMG such as the IMG 300 may provide connections and/or interfaces for various client devices such as the client devices 132a-132e to a broadband IP network such as the broadband IP network 120. An IMG processor 306 in the IMG 300 may be operable to identify a graphics processing capability and/or capacity of a client device such as the client device 132a for rendering a programming guide such as the programming guide 116. The programming guide 116 may be generated by the video client device 204 in the video receiver 200 for viewing, scheduling and/or recording of video programs. The IMG processor 306 may be operable to convert the programming guide 116 from a first format to a second format so as to generate a converted programming guide 117 based on the identified graphics processing capability and/or capacity of the client device 132a. For example, a client device such as the client device 132e, which may be a mobile device, may not have the same graphics processing capability and/or capacity of the client device 132a and/or the video receiver 110. Accordingly, different formats of the programming guide 116 may be generated for the client device 132a and the client device 132e respectively. The converted programming guide 117 may be communicated or delivered by the IMG processor 306 to the client device 132a. In this regard, for example, a location of the client device such as the client device 132a may be local with respect to a location of the IMG 300. A location of the client device such as the client device 134a may be remote with respect to a location of the IMG 300.

In an exemplary embodiment of the invention, the IMG processor 306 may be operable to identify a recording capability and/or capacity of the client device such as the client device 132a for recording one or more of the video programs by the client device 132a. For example, a client device such as the client device 132e, which may be a mobile device, may not have a recording capability and/or capacity to record a video program due to limited storage capability and/or capacity of the client device 132e. A storage location may be determined by the IMG processor 306 for storing the recorded video programs based on the recording capability and/or capacity of the client device 132a. The client device 132a may record the one or more of the video programs utilizing the delivered converted programming guide 117 and the determined storage location.

In an exemplary embodiment of the invention, the client device 132a may schedule a recording of one or more of the video programs utilizing the delivered converted programming guide 117. The client device 132a may be allowed by the IMG processor 306 to record the one or more of the video programs into the client device 132a in instances when the client device 132a may comprise a storage capability and/or capacity for storing the recording of the one or more of the video programs. The client device 132a may be allowed by the IMG processor 306 to record the one or more of the video programs into a DVR 206 in the video receiver 200 in instances when the client device 132a may not comprise a storage capability and/or capacity for storing the recording of the one or more of the video programs. The client device 132a may be allowed by the IMG processor 306 to record the one or more of the video programs into a storage device such as the storage device 140 that may be local to the IMG 300 in instances when the client device 132a may not comprise a storage capability and/or capacity for storing the recording of the one or more of the video programs, for example. The client device 132a may be allowed by the IMG processor 306 to record the one or more of the video programs into a storage device such as the storage device 160 that may be remote with respect to the IMG 300 in instances when the client device 132a may not comprise a storage capability and/or capacity for storing the recording of the one or more of the video programs, for example.

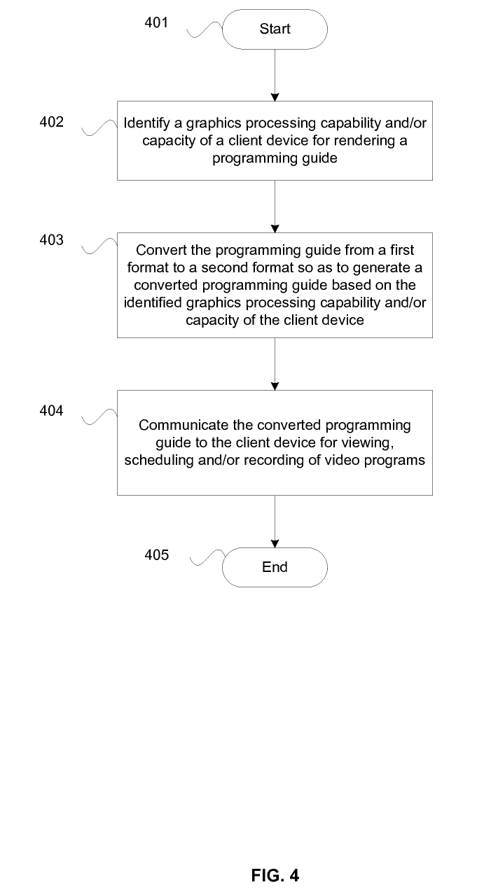

FIG. 4 is a flow chart illustrating exemplary steps for providing programming guide via an IP multimedia gateway, in accordance with an embodiment of the invention. Referring to FIG. 4, the exemplary steps start at step 401. In step 402, the IMG 112 may be operable to identify a graphics processing capability and/or capacity of a client device 132a for rendering a programming guide 116. In step 403, the IMG 112 may be operable to convert the programming guide 116 from a first format to a second format so as to generate a converted programming guide 117 based on the identified graphics processing capability and/or capacity of the client device 123a. In step 404, the converted programming guide 117 may be communicated to the client device 132a for viewing, scheduling and/or recording of video programs. The exemplary steps may proceed to the end step 405.

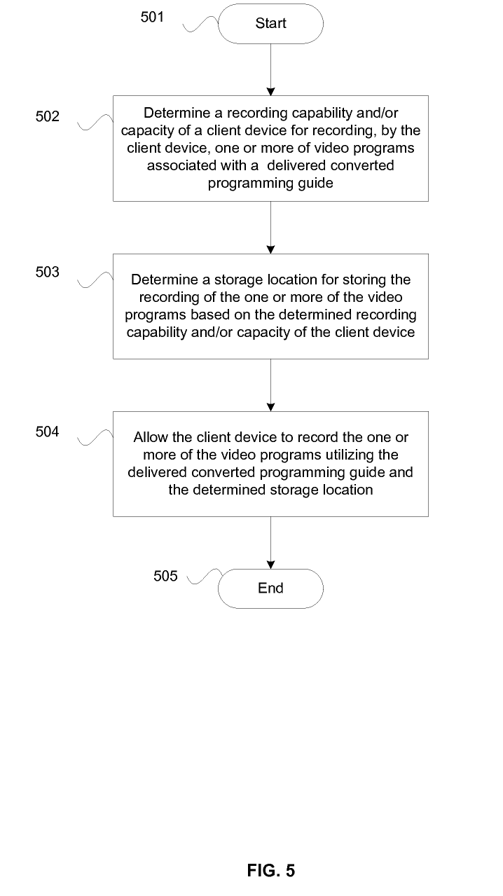

FIG. 5 is a flow chart illustrating exemplary steps for providing recording information via an IP multimedia gateway, in accordance with an embodiment of the invention. Referring to FIG. 5, the exemplary steps start at step 501. In step 502, the IMG 112 may be operable to determine a recording capability and/or capacity of a client device 132a for recording, by the client device 132a, one or more of video programs associated with a delivered converted programming guide 117. In step 503, the IMG 112 may be operable to determine a storage location for storing the recording of the one or more of the video programs based on the determined recording capability and/or capacity of the client device 132a. In step 504, the client device 132a may be allowed to record the one or more of the video programs utilizing the delivered converted programming guide 117 and the determined storage location. The exemplary steps may proceed to the end step 505.

In various embodiments of the invention, an IMG 112 that is integrated in a video receiver 110 may be operable to identify a graphics processing capability and/or capacity of a client device such as the client device 132a for rendering a programming guide such as the programming guide 116. The programming guide 116 may be generated by the video receiver 110 for viewing, scheduling and/or recording of video programs. The IMG 112 may be operable to convert the programming guide 116 from a first format to a second format so as to generate a converted programming guide 117 based on the identified graphics processing capability and/or capacity of the client device 132a. The converted programming guide 117 may be communicated by the IMG 112 to the client device 132a. For example, the converted programming guide 117 may be pushed, by the IMG 112, from the IMG 112 to the client device 132a. The converted programming guide 117 may be pulled, from the IMG 112, by the client device 132a. In this regard, for example, a location of the client device 132a may be local and/or remote with respect to a location of the IMG 112.

In an exemplary embodiment of the invention, the IMG 112 may be operable to determine a recording capability and/or capacity of the client device 132a for recording one or more of the video programs by the client device 132a. A storage location may be determined by the IMG 112 for storing the recorded video programs based on the determined recording capability and/or capacity of the client device 132a. The client device 132a may record the one or more of the video programs utilizing the converted programming guide 117 and the determined storage location. In this regard, for example, the client device 132a may record the one or more video programs into the client device 132a in instances when the client device 132a may comprise a storage capability and/or capacity to store the recorded video programs. The client device 132a may record the one or more video programs into a DVR 114 in the video receiver 110 in instances when the client device 132a may not comprise the storage capability and/or capacity to store the recorded video programs. The client device 132a may record the one or more video programs into a storage device such as the storage device 140 that may be local to the IMG 112 in instances when the client device 132a may not comprise a storage capability and/or capacity to store the recorded video programs, for example. The client device 132a may record the one or more of the video programs into a storage device such as the storage device 160 that may be remote with respect to the IMG 112 in instances when the client device 132a may not comprise a storage capability and/or capacity to store the recorded video programs, for example.

In various embodiments of the invention, an IMG 300 may be operable to determine capability and/or capacity of a client device such as the client device 132a, which may be communicatively coupled to the IMG 300, to render graphics for a received programming guide such as the programming guide 116. The IMG 300 may be operable to convert the received programming guide 116 from a first format to a second format based on the determined capability and/or capacity of the client device 132a. The converted programming guide 117 may be communicated by the IMG 112 to the client device 132a. In this regard, for example, the converted programming guide 117 may be pushed, by the IMG 300, from the IMG 300 to the client device 132a. The converted programming guide 117 may be pulled, from the IMG 300, by the client device 132a.

In an exemplary embodiment of the invention, the IMG 300 may be an IMG such as the IMG 112 which is integrated within a video receiver such as the video receiver 110. In this regard, the programming guide 116 may be generated by the video receiver 110. In another exemplary embodiment of the invention, the programming guide 116 may be received by the IMG 300 from an entity whose location may be remote with respect to a location of the IMG 300.

In an exemplary embodiment of the invention, the IMG 300 may be operable to determine a recording capability and/or capacity of the client device 132a for recording one or more of video programs associated with the programming guide 116. A storage location may be determined by the IMG 300 for storing the recorded video programs based on the determined recording capability and/or capacity of the client device 132a. The client device 132a may record the one or more of the video programs utilizing the converted programming guide 117 and the determined storage location. In this regard, for example, the client device 132a may record the one or more video programs into the client device 132a in instances when the client device 132a may comprise a storage capability and/or capacity to store the recorded video programs. The client device 132a may record the one or more video programs into a DVR 114 in a video receiver 110 communicatively coupled to the IMG 300 in instances when the client device 132a may not comprise the storage capability and/or capacity to store the recorded video programs. The client device 132a may record the one or more video programs into a storage device such as the storage device 140 that may be local to the IMG 300 in instances when the client device 132a may not comprise a storage capability and/or capacity to store the recorded video programs, for example. The client device 132a may record the one or more of the video programs into a storage device such as the storage device 160 that may be remote with respect to the IMG 300 in instances when the client device 132a may not comprise a storage capability and/or capacity to store the recorded video programs, for example.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for providing programming guide and recording information via an IP multimedia gateway.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability and/or capacity to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in an IP multimedia gateway (IMG):
determining the capability and/or capacity of a client device, which is communicatively coupled to said IMG, to render graphics for a received programming guide;
converting said received programming guide from a first format to a second format based on said determined capability and/or capacity of said client device; and
communicating said converted programming guide to said client device.

2. The method according 1, comprising pushing said converted programming guide from said IMG to said client device.

3. The method according 1, wherein said converted programming guide is pulled from said IMG by said client device.

4. The method according to claim 1, wherein:
said IMG is integrated within a video receiver; and
said programming guide is generated by said video receiver.

5. The method according to claim 1, comprising receiving said programming guide from an entity whose location is remote with respect to a location of said IMG.

6. The method according to claim 1, comprising:
determining a recording capability and/or capacity of said client device for recording one or more of video programs associated with said programming guide; and
determining a storage location for storing said recording of said one or more of said video programs based on said determined recording capability and/or capacity of said client device.

7. The method according to claim 6, wherein said client device records said one or more of said video programs utilizing said converted programming guide and said determined storage location.

8. The method according to claim 6, wherein:
if said client device comprises a storage capability and/or capacity for storing said recording of said one or more of said video programs, said client device records said one or more of said video programs into said client device; and
if said client device does not comprise a storage capability and/or capacity for storing said recording of said one or more of said video programs, said client device records said one or more of said video programs into a digital video recorder (DVR) in a video receiver communicatively coupled to said IMG.

9. The method according to claim 6, wherein if said client device does not comprise a storage capability and/or capacity for storing said recording of said one or more of said video programs, said client device records said one or more of said video programs into a storage device that is local to said IMG.

10. The method according to claim 6, wherein if said client device does not comprise a storage capability and/or capacity for storing said recording of said one or more of said video programs, said client device records said one or more of said video programs into a storage device that is remote with respect to said IMG.

11. A system for communication, the system comprising:
one or more processors and/or circuits for use in an IP multimedia gateway (IMG), wherein said one or more processors and/or circuits are operable to:
determine the capability and/or capacity of a client device, which is communicatively coupled to said IMG, to render graphics for a received programming guide;
convert said received programming guide from a first format to a second format based on said determined capability and/or capacity of said client device; and
communicate said converted programming guide to said client device.

12. The system according to claim 11, wherein said one or more processors and/or circuits are operable to push said converted programming guide from said IMG to said client device.

13. The system according to claim 11, wherein said converted programming guide is pulled from said IMG by said client device.

14. The system according to claim 11, wherein:
said IMG is integrated within a video receiver; and
said programming guide is generated by said video receiver.

15. The system according to claim 11, wherein said one or more processors and/or circuits are operable to receive said programming guide from an entity whose location is remote with respect to a location of said IMG.

16. The system according to claim 11, wherein said one or more processors and/or circuits are operable to:
determine a recording capability and/or capacity of said client device for recording one or more of video programs associated with said programming guide; and
determine a storage location for storing said recording of said one or more of said video programs based on said determined recording capability and/or capacity of said client device.

17. The system according to claim 16, wherein said client device records said one or more of said video programs utilizing said converted programming guide and said determined storage location.

18. The system according to claim 16, wherein:
if said client device comprises a storage capability and/or capacity for storing said recording of said one or more of said video programs, said client device records said one or more of said video programs into said client device; and
if said client device does not comprise a storage capability and/or capacity for storing said recording of said one or more of said video programs, said client device records said one or more of said video programs into a digital video recorder (DVR) in a video receiver communicatively coupled to said IMG.

19. The system according to claim 16, wherein if said client device does not comprise a storage capability and/or capacity for storing said recording of said one or more of said video programs, said client device records said one or more of said video programs into a storage device that is local to said IMG.

20. The system according to claim 16, wherein if said client device does not comprise a storage capability and/or capacity for storing said recording of said one or more of said video programs, said client device records said one or more of said video programs into a storage device that is remote with respect to said IMG.
